(19) United States
(12) Patent Application Publication
(10) Pub. No.: US 2021/0264174 A1
(43) Pub. Date: Aug. 26, 2021

(54) IMAGING APPARATUS FOR PROVIDING TOP VIEW

(71) Applicant: Samsung Electro-Mechanics Co., Ltd., Suwon-si (KR)

(72) Inventors: Si Young AHN, Suwon-si (KR); Sung Han WON, Suwon-si (KR); Doo Hyung KWON, Suwon-si (KR); Sung Ho HWANG, Suwon-si (KR)

(73) Assignee: Samsung Electro-Mechanics Co., Ltd., Suwon-si (KR)

(21) Appl. No.: 17/076,145

(22) Filed: Oct. 21, 2020

(30) Foreign Application Priority Data
Feb. 25, 2020 (KR) 10-2020-0022642

(51) Int. Cl. G06K 9/00; G06K 9/62; G06K 9/46; B60R 11/04; B60R 1/00

(52) U.S. Cl. CPC G06K 9/00805; G06K 9/6215; H04N 5/2253; B60R 11/04; B60R 1/002; G06K 9/4642

(57) ABSTRACT

An apparatus for providing a top view includes: a camera apparatus including a plurality of cameras; an overlap region determiner configured to match a plurality of images output from the plurality of cameras, to determine an overlap region; an image comparator configured to divide the overlap region into a plurality of blocks having a matrix form, and compare two images, among the plurality of images, output from two cameras in which imaging regions partially overlap, among the plurality of cameras, for each of the plurality of blocks; and a peripheral object detector configured to detect an object and a ground around a vehicle, according to a comparison result of the image comparator.

### CROSS-REFERENCE TO RELATED APPLICATIONS

This application claims the benefit under 35 U.S.C. §119(a) of Korean Patent Application No. 10-2020-0022642 filed on Feb. 25, 2020 in the Korean Intellectual Property Office, the entire disclosure of which is incorporated herein by reference for all purposes.

### BACKGROUND

### 1. Field

The following description relates to an imaging apparatus for providing a top view.

### 2. Description of Related Art

Blind spots that a driver cannot see in driving may be a major risk factor threatening the safety of the driver. It may be difficult to pay attention to a rear direction of a vehicle because the driver of the vehicle may be generally looking only in a front direction of the vehicle. Various apparatuses for removing blind spots have been developed to eliminate such a major risk factor from driving the vehicle. In order to remove blind spots that cannot be seen from side mirrors, apparatuses that integrate a secondary mirror, or detect an object behind the vehicle by an infrared sensor and alert the driver by an alarm, have been applied to vehicles. In recent years, methods have been developed to reduce blind spots by outputting an image in a rear direction of a vehicle to a driver's display. However, these methods have disadvantages of essentially removing only a portion of blind spots that a driver cannot see.

In particular, for large vehicles, there may be many sites that cannot be identified by side mirrors or rearview mirrors only. Before starting to drive a vehicle, a driver should look around the vehicle with the naked eye and determine whether there are obstacles, to prevent the occurrence of traffic safety accidents, such as contact accidents with vehicles and contact accidents with humans or animals. In addition, in a case of a driver who wants to park a vehicle, since it may not be possible to check left and right directions and a rear direction at a glance, a driver who is inexperienced may risk contact accidents with a vehicle parked nearby, or with a parking pole. Furthermore, even if an obstacle is located in front of a vehicle, an obstacle may be obscured by a vehicle frame located between a windshield and a door of the vehicle, or may lead to accidents with humans if infants or children sitting or playing in front of or behind the vehicle cannot be seen.

Therefore, recently, apparatuses in which images around a vehicle are captured by cameras respectively attached to a front portion, a rear portion, a left side portion, and a right side portion of the vehicle, and the captured peripheral images are combined to provide a view (e.g., a top view) of the vehicle viewed in a downward direction from a point in space above the vehicle via a display mounted on a driver's seat, have been developed.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an apparatus for providing a top view includes: a camera apparatus including a plurality of cameras; an overlap region determiner configured to match a plurality of images output from the plurality of cameras, to determine an overlap region; an image comparator configured to divide the overlap region into a plurality of blocks having a matrix form, and compare two images, among the plurality of images, output from two cameras in which imaging regions partially overlap, among the plurality of cameras, for each of the plurality of blocks; and a peripheral object detector configured to detect an object and a ground around a vehicle, according to a comparison result of the image comparator.

The plurality of cameras may include a left top view camera, a right top view camera, a front top view camera, and a rear top view camera.

The overlap region determiner may be further configured to match the plurality of images output from the plurality of cameras by matching two images output from two cameras in which imaging regions partially overlap, among the left top view camera, the right top view camera, the front top view camera, and the rear top view camera.

The overlap region determiner may be further configured to match the plurality of images output from the plurality of cameras by matching: two images output from the left top view camera and the front top view camera, two images output from the front top view camera and the right top view camera, two images output from the right top view camera and the rear top view camera, and two images output from the rear top view camera and the left top view camera.

The image comparator may be further configured to compare a first comparison image and a second comparison image, corresponding to the overlap region, in each of the two images output from the two cameras in which the imaging regions partially overlap.

The image comparator may be further configured to compare the first comparison image and the second comparison image to determine whether data of the first comparison image and data of the second comparison image are matched or mismatched, for each of the plurality of blocks.

The peripheral object detector may be further configured to: determine a first block group, among the plurality of blocks, in which the data of the first comparison image and the data of the second comparison image are matched, as a region corresponding to the ground; and determine a second block group, among the plurality of blocks, in which the data of the first comparison image and the data of the second comparison image are mismatched, as a region corresponding to the object.

In another general aspect, an apparatus for providing a top view includes: a camera apparatus including a plurality of cameras; an overlap region determiner configured to match a plurality of images output from the plurality of cameras, to determine an overlap region; an image comparator configured to divide the overlap region into a plurality of blocks having a matrix form, and compare two images, among the plurality of images, output from two cameras in which imaging regions partially overlap, among the plurality of cameras, for each of the plurality of blocks; and a peripheral object detector configured to calculate a distance between an object around a vehicle and the vehicle, according to a comparison result of the image comparator.

The plurality of cameras may include a left top view camera, a right top view camera, a front top view camera, and a rear top view camera.

The overlap region determiner may be further configured to match the plurality of images output from the plurality of cameras by matching two images output from two cameras in which imaging regions partially overlap, among the left top view camera, the right top view camera, the front top view camera, and the rear top view camera.

The apparatus for providing a top view, according to claim 9, wherein the overlap region determiner is further configured to match the plurality of images output from the plurality of cameras by matching: two images output from the left top view camera and the front top view camera, two images output from the front top view camera and the right top view camera, two images output from the right top view camera and the rear top view camera, and two images output from the rear top view camera and the left top view camera.

The image comparator may be further configured to compare a first comparison image and a second comparison image, corresponding to the overlap region, in each of the two images output from the two cameras in which the imaging regions partially overlap.

The image comparator may be further configured to compare the first comparison image and the second comparison image to determine whether data of the first comparison image and data of the second comparison image are matched or mismatched, for each of the plurality of blocks.

The peripheral object detector may be further configured to calculate the distance between the object around the vehicle and the vehicle according to: a first block group, among the plurality of blocks, in which the data of the first comparison image and the data of the second comparison image are matched; and a second block group, among the plurality of blocks, in which the data of the first comparison image and the data of the second comparison image are mismatched.

The peripheral object detector may be further configured to calculate the distance between the object around the vehicle and the vehicle according to at least one block, among the first block group, disposed adjacent to the second block group.

The peripheral object detector may be further configured to calculate the distance between the object around the vehicle and the vehicle, according to a block, among the first block group, disposed adjacent to the second block group and closest to the vehicle.

In another general aspect, a vehicle includes: cameras mounted on respective surfaces of the vehicle; and one or more processors. The one or more processors are configured to: determine an overlap region in which two images respectively output from two cameras among the cameras partially overlap; divide the overlap region into a plurality of blocks having a matrix form, and compare the two images for each of the plurality of blocks; and detect an object and a ground around the vehicle, according to a result of the comparing of the two images.

The one or more processors may be further configured to: determine first blocks, among the blocks, in which respective data of the two images match, as corresponding to the ground; and determine second blocks, among the blocks, in which the respective data of the two images do not match, as corresponding to the object.

The one or more processors may be further configured to convert the two images to be in respective top view perspectives prior to determining the overlap region.

Other features and aspects will be apparent from the following detailed description, the drawings, and the claims.

### BRIEF DESCRIPTION OF DRAWINGS

FIG. 1 is a block diagram illustrating an imaging apparatus for providing a top view, according to an embodiment.

FIG. 2 is a view illustrating an arrangement of a camera apparatus and images output from the camera apparatus, according to an embodiment.

FIG. 3 is a view illustrating an overlap region, according to an embodiment.

FIG. 4 is a view illustrating a comparison result of an image comparator, according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after gaining an understanding of the disclosure of this application. Further, although the examples described herein have a variety of configurations, other configurations are possible as will be apparent after an understanding of the disclosure of this application.

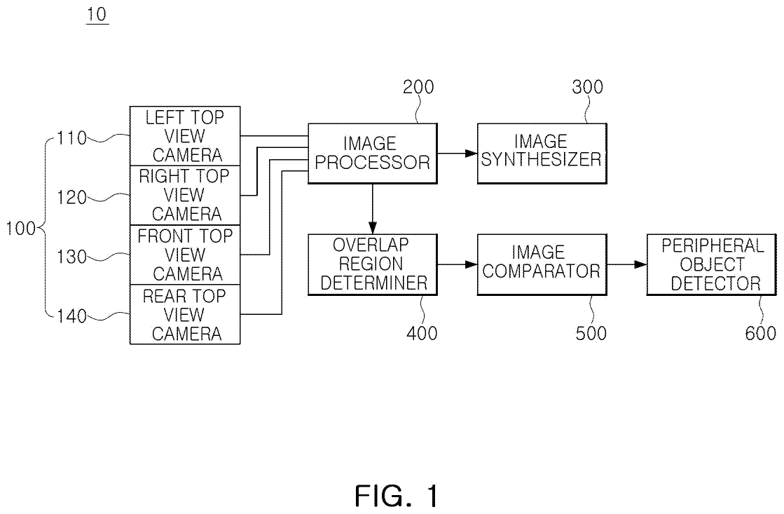

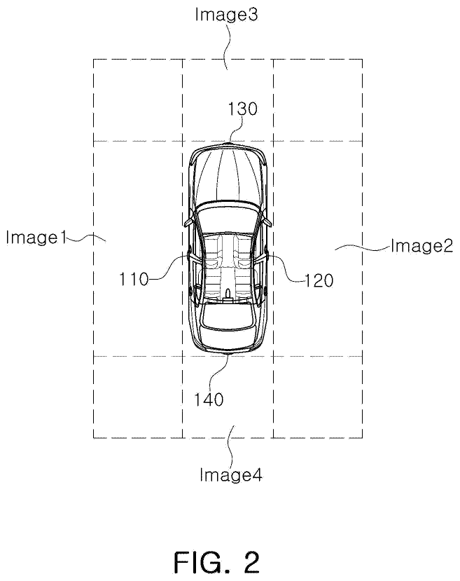

FIG. 1 is a block diagram illustrating an imaging apparatus 10 for providing a top view, according to an embodiment. FIG. 2 is a view illustrating an arrangement of a camera apparatus 100 and images output from the camera apparatus 100, according to an embodiment.

Referring to FIG. 1, the imaging apparatus 10 may include, for example, a camera apparatus 100, an image processor 200, an image synthesizer 300, an overlap region determiner 400, an image comparator 500, and a peripheral object detector 600.

Referring to FIGS. 1 and 2, the camera apparatus 100 may include a plurality of cameras. For example, the plurality of cameras may include a left top view camera 110 configured to image in a leftward direction of a vehicle, a right top view camera 120 configured to image in a rightward direction of the vehicle, a front top view camera 130 configured to image in a front direction of the vehicle, and a rear top view camera 140 configured to image in a rear direction of the vehicle.

As an example, the left top view camera 110, the right top view camera 120, the front top view camera 130, and the rear top view camera 140 may respectively image in respective downward directions, e.g., in respective ground-facing directions, based on respective left, right, front, and rear external spaces, adjacent to the vehicle.

Each of the left top view camera 110, the right top view camera 120, the front top view camera 130, and the rear top view camera 140 may include a wide-angle camera including a fisheye lens, for example.

As shown in FIG. 2, the left top view camera 110 may be disposed on a left external side surface of the vehicle. The right top view camera 120 may be disposed on a right external side surface of the vehicle. The front top view camera 130 may be disposed on a front external surface of the vehicle. The rear top view camera 140 may be disposed on a rear external surface of the vehicle.

Referring to FIG. 2, a first image (Image1) output from the left top view camera 110, a second image (Image2) output from the right top view camera 120, a third image (Image3) output from the front top view camera 130, and a fourth image (Image4) output from the rear top view camera 140 may be provided to the image processor 200.

In the above description, although the camera apparatus 100 is described as being composed of four (4) cameras, the number of cameras may be changed, according to embodiments.

The image processor 200 may receive the first image (Image1) output from the left top view camera 110, the second image (Image2) output from the right top view camera 120, the third image (Image3) output from the front top view camera 130, and the fourth image (Image4) output from the rear top view camera 140.

The image processor 200 may convert the first image (Image1) output from the left top view camera 110, the second image (Image2) output from the right top view camera 120, the third image (Image3) output from the front top view camera 130, and the fourth image (Image4) output from the rear top view camera 140, to form respective top views thereof.

The image processor 200 may apply algorithms such as distortion correction, viewpoint conversion, or the like, to the first image (Image1), the second image (Image2), the third image (Image3), and the fourth image (Image4), and may convert the first image (Image1), the second image (Image2), the third image (Image3), and the fourth image (Image4) to form respective top views thereof.

The converted first image (Image1), the converted second image (Image2), the converted third image (Image3), and the converted fourth image (Image4), which have been converted to be respective top views by the image processor 200, may be transferred to the image synthesizer 300 and the overlap region determiner 400.

The image synthesizer 300 may receive the converted first image (Image1), the converted second image (Image2), the converted third image (Image3), and the converted fourth image (Image4), which have been converted to be the respective top views, from the image processor 200.

The image synthesizer 300 may synthesize the converted first image (Image1), the converted second image (Image2), the converted third image (Image3), and the converted fourth image (Image4), to create top view images, for example, images of the vehicle that a driver views in a downward direction from a point in space above the vehicle.

The overlap region determiner 400 may determine an overlap region of the converted first image (Image1), the converted second image (Image2), the third converted image (Image3), and the converted fourth image (Image4).

Since the left top view camera 110, the right top view camera 120, the front top view camera 130, and the rear top view camera 140, which are each composed of the wide-angle camera, may have a wide-angle of view, imaging regions of a portion of the left top view camera 110, the right top view camera 120, the front top view camera 130, and the rear top view camera 140 may partially overlap.

For example, imaging regions of the left top view camera 110 and the front top view camera 130 may partially overlap, imaging regions of the front top view camera 130 and the right top view camera 120 may partially overlap, imaging regions of the right top view camera 120 and the rear top view camera 140 may partially overlap, and imaging regions of the rear top view camera 140 and the left top view camera 110 may partially overlap.

The overlap region determiner 400 may match two images output from two cameras in which imaging regions partially overlap, among the left top view camera 110, the right top view camera 120, the front top view camera 130, and the rear top view camera 140, to determine the overlap region.

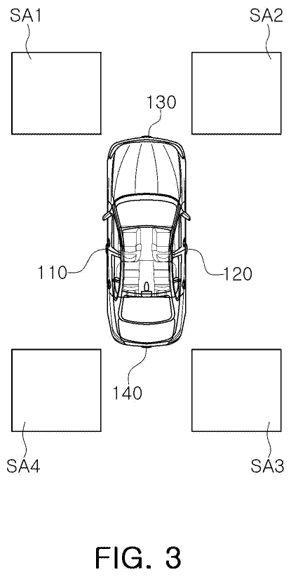

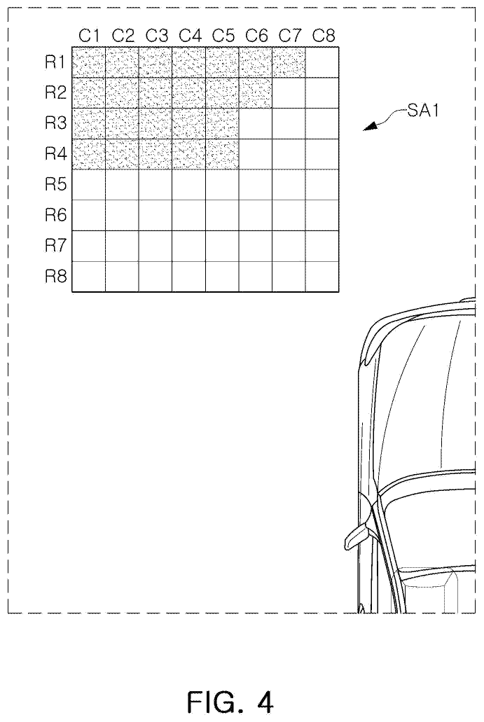

FIG. 3 is a view illustrating an overlap region, according to an embodiment. FIG. 4 is a view illustrating a comparison result of an image comparator, according to an embodiment.

For example, an overlap region determiner 400 may match the converted first image (Image1) and the converted third image (Image3) to determine a first overlap region (SA1), may match the converted second image (Image2) and the converted third image (Image3) to determine a second overlap region (SA2), may match the converted second image (Image2) and the converted fourth image (Image4) to determine a third overlap region (SA3), and may match the first image (Image1) and the fourth image (Image4) to determine a fourth overlap region (SA4).

For example, in each of the two images output from two cameras in which imaging regions partially overlap, the image comparator 500 may compare a first comparison image and a second comparison image, corresponding to an overlap region.

For example, referring to FIGS. 2 and 3, the image comparator 500 may compare a first comparison image of the first image (Image1), corresponding to the first overlap region (SA1), and a second comparison image of the third image (Image3), corresponding to the first overlap region (SA1).

Referring to FIG. 4, an image comparator 500 may divide the first overlap region (SA1) into a plurality of blocks. As an example, the image comparator 500 may divide the first overlap region (SA1) into a plurality of blocks having a matrix form.

The image comparator 500 may compare the first comparison image and the second comparison image to determine whether data of the first comparison image and data of the second comparison image are matched or mismatched, for each of the plurality of blocks.

For example, the image comparator 500 may compare the first comparison image of the first image (Image1), corresponding to the first overlap region (SA1), and the second comparison image of the third image (Image3), corresponding to the first overlap region (SA1), to determine whether data of the first comparison image and data of the second comparison image are matched or mismatched, for each of the plurality of blocks.

In FIG. 4, a first block group, among the plurality of blocks in the first overlap region (SA1), which is not emphasized by shading, may correspond to a region in which data of the first comparison image and data of the second comparison image are matched, and a second block group, among the plurality of blocks in the first overlap region (SA1), which is emphasized by shading, may correspond to a region in which data of the first comparison image and data of the second comparison image are mismatched.

The peripheral object detector 600 may detect an object and a ground around the vehicle, according to a comparison result of the image comparator 500.

For example, the peripheral object detector 600 may determine, a first block group, among the plurality of blocks of the overlap region, in which the data of the first comparison image and the data of the second comparison image are matched, to be a region corresponding to the ground. For example, the peripheral object detector 600 may determine a second block group, among the plurality of blocks of the overlap region, in which the data of the first comparison image and the data of the second comparison image are mismatched, to be a region corresponding to the object.

For example, in FIG. 4, the first block group, among the plurality of blocks of the first overlap region (SA1), which is not emphasized by shading, may be determined to be a region corresponding to the ground, and the second block group, among the plurality of blocks of the first overlap region (SA1), which is emphasized by shading, may be determined to be a region corresponding to the object around the vehicle.

The peripheral object detector 600 may calculate a distance between the object around the vehicle and the vehicle, according to the first block group in which the data of the first comparison image and the data of the second comparison image are matched, and the second block group in which the data of the first comparison image and the data of the second comparison image are mismatched.

The peripheral object detector 600 may detect the distance between the object around the vehicle and the vehicle, according to at least one block, among the first block group, disposed adjacent to the second block group.

For example, the peripheral object detector 600 may detect the distance between the object around the vehicle and the vehicle, according to a block, among the first block group, disposed adjacent to the second block group and closest to the vehicle.

For example, referring to FIG. 4, the peripheral object detector 600 may determine a block R5, C6 disposed adjacent to the second block group and closest to the vehicle, among the first block group, as a location of the ground closest to the object, and may detect a distance between the object around the vehicle and the vehicle, according to the block R5, C6.

According to embodiments disclosed herein, an imaging apparatus for providing a top view may compare two images output from two cameras in which imaging regions partially overlap, to detect a peripheral object with high precision, and furthermore, to calculate an accurate distance between the peripheral object and a vehicle.

In addition, according to embodiments disclosed herein, an imaging apparatus for providing a top view may calculate an accurate distance between the peripheral object and a vehicle without a separate sensor, to reduce manufacturing costs.

The image processor 200, the image synthesizer 300, the overlap region determiner 400, the image comparator 500, and the peripheral object detector 600 in FIGS. 1 to 4 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for providing a top view, comprising:
a camera apparatus including a plurality of cameras;
an overlap region determiner configured to match a plurality of images output from the plurality of cameras, to determine an overlap region;
an image comparator configured to divide the overlap region into a plurality of blocks having a matrix form, and compare two images, among the plurality of images, output from two cameras in which imaging regions partially overlap, among the plurality of cameras, for each of the plurality of blocks; and
a peripheral object detector configured to detect an object and a ground around a vehicle, according to a comparison result of the image comparator.

2. The apparatus according to claim 1, wherein the plurality of cameras comprise a left top view camera, a right top view camera, a front top view camera, and a rear top view camera.

3. The apparatus according to claim 2, wherein the overlap region determiner is further configured to match the plurality of images output from the plurality of cameras by matching two images output from two cameras in which imaging regions partially overlap, among the left top view camera, the right top view camera, the front top view camera, and the rear top view camera.

4. The apparatus according to claim 2, wherein the overlap region determiner is further configured to match the plurality of images output from the plurality of cameras by matching:
two images output from the left top view camera and the front top view camera,
two images output from the front top view camera and the right top view camera,
two images output from the right top view camera and the rear top view camera, and
two images output from the rear top view camera and the left top view camera.

5. The apparatus according to claim 1, wherein the image comparator is further configured to compare a first comparison image and a second comparison image, corresponding to the overlap region, in each of the two images output from the two cameras in which the imaging regions partially overlap.

6. The apparatus according to claim 5, wherein the image comparator is further configured to compare the first comparison image and the second comparison image to determine whether data of the first comparison image and data of the second comparison image are matched or mismatched, for each of the plurality of blocks.

7. The apparatus according to claim 6, wherein the peripheral object detector is further configured to:
determine a first block group, among the plurality of blocks, in which the data of the first comparison image and the data of the second comparison image are matched, as a region corresponding to the ground; and
determine a second block group, among the plurality of blocks, in which the data of the first comparison image and the data of the second comparison image are mismatched, as a region corresponding to the object.

8. An apparatus for providing a top view, comprising:
a camera apparatus including a plurality of cameras;
an overlap region determiner configured to match a plurality of images output from the plurality of cameras, to determine an overlap region;
an image comparator configured to divide the overlap region into a plurality of blocks having a matrix form, and compare two images, among the plurality of images, output from two cameras in which imaging regions partially overlap, among the plurality of cameras, for each of the plurality of blocks; and
a peripheral object detector configured to calculate a distance between an object around a vehicle and the vehicle, according to a comparison result of the image comparator.

9. The apparatus according to claim 8, wherein the plurality of cameras comprise a left top view camera, a right top view camera, a front top view camera, and a rear top view camera.

10. The apparatus according to claim 9, wherein the overlap region determiner is further configured to match the plurality of images output from the plurality of cameras by matching two images output from two cameras in which imaging regions partially overlap, among the left top view camera, the right top view camera, the front top view camera, and the rear top view camera.

11. The apparatus according to claim 9, wherein the overlap region determiner is further configured to match the plurality of images output from the plurality of cameras by matching:
two images output from the left top view camera and the front top view camera,
two images output from the front top view camera and the right top view camera,
two images output from the right top view camera and the rear top view camera, and
two images output from the rear top view camera and the left top view camera.

12. The apparatus according to claim 8, wherein the image comparator is further configured to compare a first comparison image and a second comparison image, corresponding to the overlap region, in each of the two images output from the two cameras in which the imaging regions partially overlap.

13. The apparatus according to claim 12, wherein the image comparator is further configured to compare the first comparison image and the second comparison image to determine whether data of the first comparison image and data of the second comparison image are matched or mismatched, for each of the plurality of blocks.

14. The apparatus according to claim 13, wherein the peripheral object detector is further configured to calculate the distance between the object around the vehicle and the vehicle according to:
a first block group, among the plurality of blocks, in which the data of the first comparison image and the data of the second comparison image are matched; and
a second block group, among the plurality of blocks, in which the data of the first comparison image and the data of the second comparison image are mismatched.

15. The apparatus according to claim 14, wherein the peripheral object detector is further configured to calculate the distance between the object around the vehicle and the vehicle according to at least one block, among the first block group, disposed adjacent to the second block group.

16. The apparatus according to claim 15, wherein the peripheral object detector is further configured to calculate the distance between the object around the vehicle and the vehicle, according to a block, among the first block group, disposed adjacent to the second block group and closest to the vehicle.

17. A vehicle, comprising:
cameras mounted on respective surfaces of the vehicle; and
one or more processors configured to:
determine an overlap region in which two images respectively output from two cameras among the cameras partially overlap;
divide the overlap region into a plurality of blocks having a matrix form, and compare the two images for each of the plurality of blocks; and
detect an object and a ground around the vehicle, according to a result of the comparing of the two images.

18. The vehicle of claim 17, wherein the one or more processors are further configured to:
determine first blocks, among the blocks, in which respective data of the two images match, as corresponding to the ground; and
determine second blocks, among the blocks, in which the respective data of the two images do not match, as corresponding to the object.

19. The vehicle of claim 17, wherein the one or more processors are further configured to convert the two images to be in respective top view perspectives prior to determining the overlap region.
